(19) United States
(12) Patent Application Publication
(10) Pub. No.: US 2008/0126393 A1
(43) Pub. Date: May 29, 2008

(54) COMPUTER PROGRAM PRODUCT AND SYSTEM FOR ANNOTATING A PROBLEM SQL STATEMENT FOR IMPROVED UNDERSTANDING

(76) Inventors: Patrick D. Bossman, Alexandria, VA (US); Chih Jieh Chang, San Jose, CA (US); Gene Fuh, San Jose, CA (US); Tracy Ho, San Jose, CA (US); Chan-hua Liu, San Jose, CA (US); Kevin M. McBride, Mountain View, CA (US); Xinyu Wang, Beijing (CN)

Correspondence Address: Kunzler & McKenzie, 8 EAST BROADWAY, SUITE 600, SALT LAKE CITY, UT, 84111, US

(21) Appl. No.: 11/564,748

(22) Filed: Nov. 29, 2006

(51) Int. Cl. G06F 17/30

(52) U.S. Cl. 707/102

(57) ABSTRACT

A computer program product and system are disclosed for parsing a problem SQL statement into query clauses, formatting these query clauses into a hierarchical tree structure, generating performance statistics for clauses that have associated performance statistics and displaying the formatted SQL statement with each clause contained on a separate display line annotated with its corresponding associated performance statistics on the same display line and with the hierarchical tree structure represented by indention levels of the separate display lines.

### BACKGROUND OF THE INVENTION

1. Field of the Invention

The present invention relates to relational database accessing and more particularly relates to a method for annotating a statement written in a query language such as industry standard ‘Structured Query Language’ (SQL).

2. Description of the Related Art

SQL is a data sublanguage that works particularly well on a multi-user client/server computer system, although it can also be used on a stand-alone computer. SQL origins can be directly traced to an influential paper, “A Relational Model of Data for Large Shared Data Banks”, by Dr. Edgar F. Codd,—a researcher at IBM's San Jose research center. This paper was published in June, 1970 in the Association for Computing Machinery (ACM) journal, although drafts of it were circulated internally within IBM during 1969. Codd's model has become widely accepted as the definitive model for relational database management systems (RDBMS).

SQL was first adopted as a standard by the American National Standards Institute (ANSI) in 1986 and ISO (International Organization for Standardization) in 1987. The latest SQL standard, SQL:2003, has been adopted by both ANSI and ISO in 2003.

Today, many business software ‘client’ applications regularly use the SQL data sublanguage to access very large relational databases which are serviced by dedicated software ‘server’ database management applications. A typical client/server configuration and example SQL code is depicted in FIG. 1.

FIG. 1 depicts a computer user 5 sitting at a user interface 10, such as a personal computer or a workstation. The particular computer transaction being carried out in FIG. 1 is one in which an application program 20, such as an ‘e-business’ program, is running at the user interface 10 and communicating with a centralized database 30 via a network connection such as is common practice in the prior art. The centralized database 30 may be, for example, a master sales leads list or similar database. This database 30 resides on a server computer and maintained on that server computer by a dedicated database management system 40, commonly abbreviated as DBMS.

The industry has adopted, a standardized data sublanguage, SQL, to facilitate data queries in such a client-server system. For example, an SQL statement 100 may be written to requests a list of employees that have made sales in a previous month, from the data base 30, for the purpose of awarding bonuses to those (deserving) employees. Alternatively this SQL statement 100 could be generated by the application program 20. In this example, the DBMS 40 would extract data existing in the database 30 and return example data 101 which lists the employee names and the computed bonus.

Those skilled in the art will recognize that present application programs 20 typically generate SQL statements that are considerably more complex than the trivial example shown in FIG. 1.

The speed and efficiency with which SQL accesses the desired data affects the operating cost and application availability of these database systems. For example, inefficient SQL code, such as poorly written code, can use significantly more hardware resources and server CPU time than optimally written code. This inefficiency slows down the overall client-server system and incurs significant monthly software usage for the inefficient application. If the frequency of executing an SQL is greater than the time it takes to execute the SQL, then a backlog of work accumulates and the application executing the work (and possibly all other applications on the system) becomes unavailable to users.

One of the current approaches to solving this problem of inefficient SQL code is to ‘tune’ the performance of the SQL, so it executes more quickly and consumes less system resources. However, such SQL performance tuning requires significant skill and experience and the complexity of SQL is constantly evolving to meet more complex business needs. Many database administrators and applications developers do not have the either the required skills or available time to tune all of their SQL. In addition, before SQL performance tuning can happen, analysis of the problem SQL statements is required so that users understand which of these SQL statements determine the overall inefficiency.

Database tools vendors, such as BMC, Cogito, and Quest offer tools that capture and identify slow-running, problem SQL code, but such tools have fallen short because they do not necessarily provide additional information to understand the context of what is wrong with the particular SQL statements. For example, none of these tools offer users the ability to perform deeper analysis of the problem SQL by displaying related statistics adjacent to each particular query predicate.

There is great interest in solving the aforementioned problem by those skilled in the art. Some teacher a language structural analyzer that receives an SQL query and produces rationale to record reasons for selecting optimization choices, at a database server, while generating an execution plan for that query. This attempted solution fails however, to provide annotations of the SQL query within itself, such as with database catalog statistics and cost estimation information. This failure prevents the user from evaluating for himself certain potential performance issues even though it is precisely those issues that prevent the optimizer from forming a good execution plan.

Other proposed solutions describe performing automatic SQL analyses such as statistics analysis, access path analysis, and other analyses, based on ‘SQL Profiling’. SQL Profiling is based on the SQL queries' performance characteristics as executed by a database optimizer. Some propose not annotating individual SQL query predicates with any performance characteristics for user inspection. Instead, they proposed SQL tuning at the server as opposed to the SQL statement or client applications.

To solve the aforementioned problems associated tuning SQL statements, the present invention is a unique method for simple and reliable SQL statement annotation which overcomes the complexities and logistical issues common up to now in relational database accessing.

### SUMMARY OF THE INVENTION

From the foregoing discussion, it should be apparent that a need exists for a computer program product and system for annotating a problem SQL statement with associated performance statistics so that a data base analyst can readily understand which query clauses within the problem SQL statement may be replaced with alternate query clauses to improve performance. Beneficially, such an apparatus, system, and method would parse the problem SQL statement into query clauses, format these query clauses into a hierarchical tree structure, generate performance statistics for each of the query clauses that have associated performance statistics and display the formatted SQL statement with each query clause contained on a separate display line annotated with its corresponding associated performance statistics on the same display line and with the hierarchical tree structure represented by indention levels of the separate display lines.

The present invention has been developed in response to the present state of the art, and in particular, in response to the problems and needs in the art that have not yet been fully solved by currently available SQL optimization techniques. Accordingly, the present invention has been developed to provide a computer program product and system for annotating a problem SQL statement for improved understanding that overcomes many or all of the above-discussed shortcomings in the art.

The present invention helps to solve the aforementioned problem by providing an easy to use graphical user interface (GUI) for displaying a problem SQL statement and providing the option to view different statistics associated with that SQL statement. The invention parses each SQL statement into query predicates and also highlights related rows depending on certain user selected options. As a result, the inventive method of annotating SQL statements allows users to analyze these SQL statements more effectively and efficiently than is possible in the present art.

The computer program product and system of the present invention configured to annotate a problem SQL statement for improved understanding includes a plurality of modules configured to functionally execute the necessary steps of parsing, formatting, optimizing, generating performance statistics including predicted, and displaying formatted SQL statements. These functional units are described as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code may be a single instruction, or many instructions, and may even be distributed over several different code segments, among different programs, and across several memory devices.

The present invention, in one embodiment, is configured as a computer program product comprising a computer readable medium having computer usable program code programmed for annotating a problem SQL statement. The computer program product receives a problem SQL statement from one of a plurality of SQL statement sources, parses the problem SQL statement into a plurality of clauses. The computer program product formats the plurality of clauses into a hierarchical tree structure comprising indented lines where each of the clauses is contained on one of the indented lines. The computer program product displays each of the indented lines containing the parsed clauses of the problem SQL statement on a separate line within a display window and generates performance statistics for the clauses having associated statistics. Each performance statistic corresponds to a specific clause. The computer program product annotates the problem SQL statement by displaying one or more performance statistics on a line within the display window such that the one or more performance statistics are displayed adjacent to the corresponding clause.

A system of the present invention is also presented. The system includes a SQL optimizer, a text processor, a performance predictor, and a graphical display. The SQL optimizer receives a problem SQL statement and transforms the problem SQL statement into an alternate form that includes suggested clause changes. The text processor parses the alternate form SQL statement into a plurality of alternate clauses and formats the alternate clauses into a hierarchical tree structure comprising indented lines where each of the alternate clauses is positioned on one of the indented lines. The performance predictor predicts performance statistics for the alternate clauses having associated statistics. Each predicted performance statistic corresponds to a specific alternate clause. The graphical display displays each of the indented lines containing the parsed alternate clauses of the alternate SQL statement on a separate line within a display window and one or more predicted performance statistics adjacent to the corresponding alternate clause.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts a client/server computer system suitable for running SQL code as known to those skilled in the art;

FIG. 2 is a screen shot of one embodiment of a computer program product for analyzing a problem SQL statement;

FIG. 3 depicts details of certain components of the screen shot of FIG. 2;

FIG. 4 is schematic flow chart diagram illustrating one embodiment of a system for analyzing a problem SQL statement in accordance with the present invention; and

FIG. 5 is an illustrative screen shot of one embodiment of the system of FIG. 4.

### DETAILED DESCRIPTION OF THE INVENTION

The described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

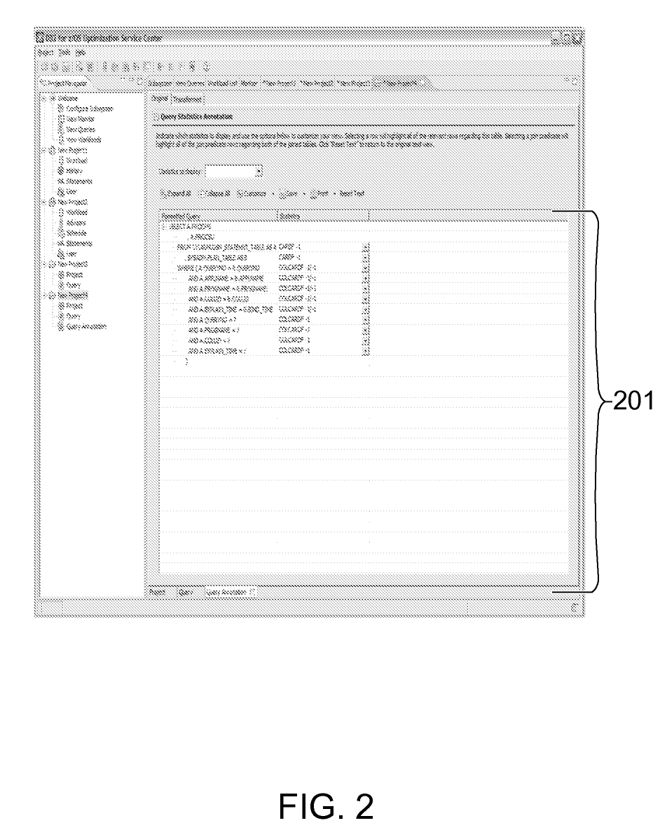

Referring now to FIG. 2, which depicts a screen shot of one embodiment of a computer program product for analyzing a problem SQL statement. The screen shot shows the results after a problem SQL statement is provided, parsed, formatted, annotated, and displayed within a graphic window 201. In the context of the present invention, ‘Problem SQL Statement’ is a term which describes possibly inefficient, poorly written, or unoptimized SQL code.

The present invention provides automated SQL query annotation which enables less skilled database administrators to become aware of important issues that they would not have either the time or skill to recognize. The use of SQL query annotations, as part of the overall SQL analysis, provides more detailed information in a very useful format. By seeing what tables and search conditions affect overall system performance, users can better determine if they want to leave clauses of the SQL statement alone, make changes, or accept suggestions of an automated advisors. Advantageously, other features can be made available at a Graphical User interface (GUI) to further facilitate SQL statement tuning. For example, highlighting of rows visually indicates to users the related rows which facilitate effective analysis and a tabbed display enables comparison viewing between an original query and a transformed query and can display aggregated critical performance information to improve overall understanding.

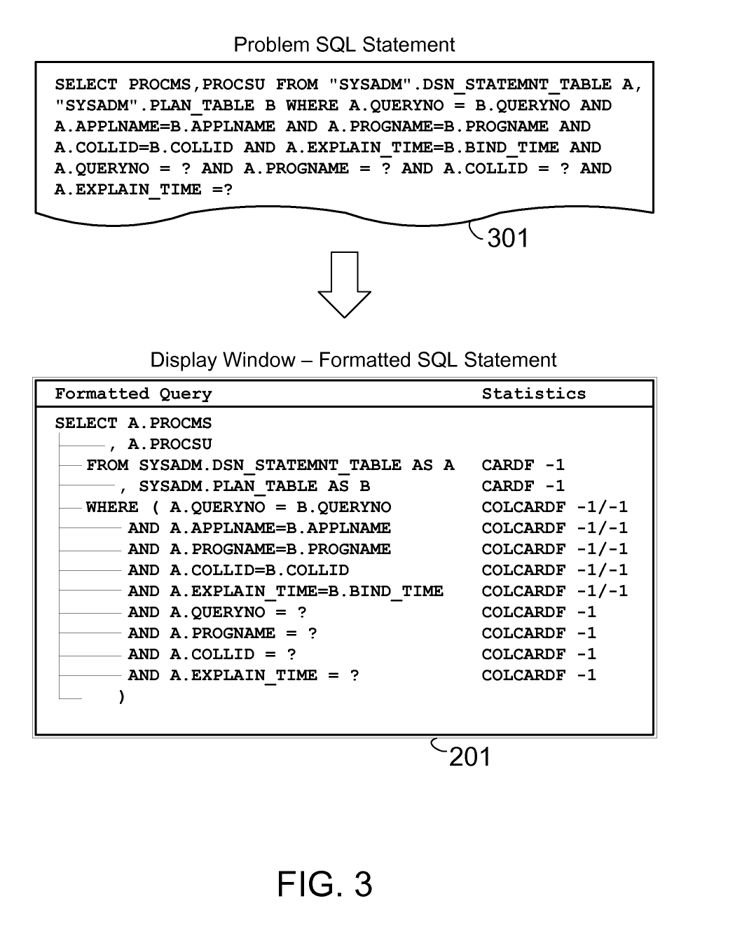

FIG. 3 depicts both the problem SQL statement 301 that has been submitted and the resultant graphical display 201.

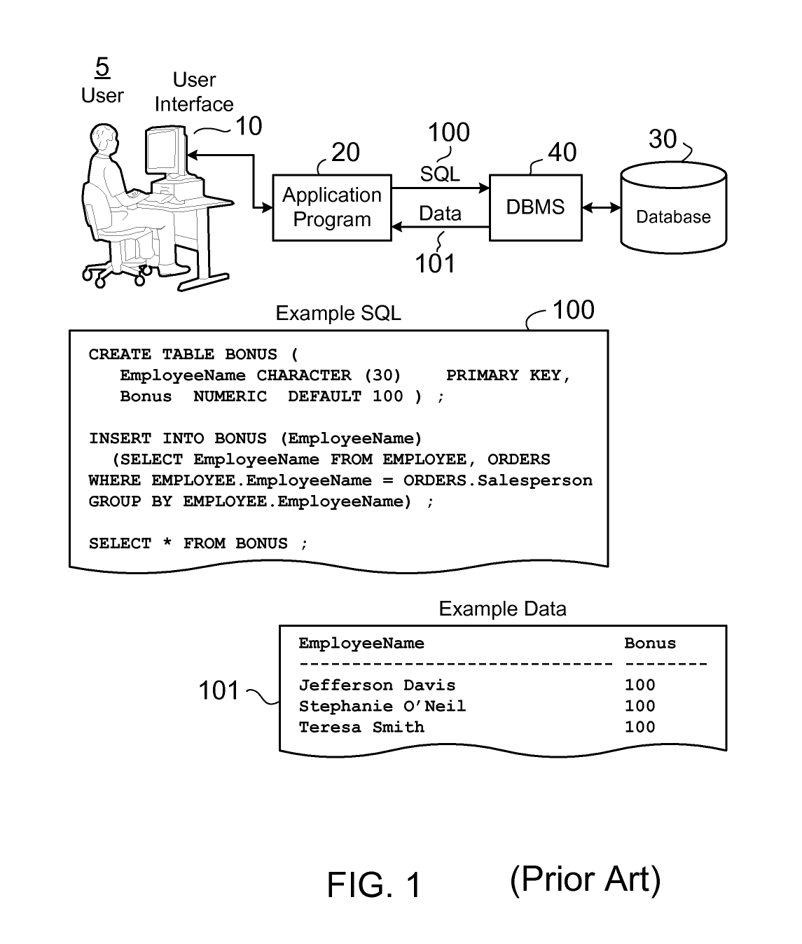

A first embodiment of the present invention provides a computer program product that derives the data content and format as displayed in graphical display window 201. More specifically, the computer program product of the present invention receives problem SQL statement from any one of a number of possible sources, where one possible source is the application program 20 as depicted in FIG. 1. Other possible sources of problem SQL statements include: statement lists generated by the DBMS 40, such as by an internal monitoring tool, a dynamic statement cache, or an external query reporting tool. Still other possible sources include, but are not limited to: database catalogs, alternate forms generated by SQL optimizers, or even statements that have been manually entered or copied into a text field.

After the computer program product of the present invention receives the problem SQL statement, the computer program product parses this statement into a plurality of separate clauses and formats these clauses into a hierarchical tree structure representation of the original problem SQL statement. This resultant hierarchical tree structure is displayed in the graphical display window 201 with each clause on a single line and with the tree structure represented by multiple indentation levels.

The computer program product recognizes that certain clauses of the parsed SQL statement can be annotated with performance statistics that might prove useful for a database analyst, such as computer user 5 shown in FIG. 1, who desires to further understand the problem SQL statement 301 and the opportunities that may exist for optimize this statement. Therefore, for those clauses having associated performance statistics, the present invention generates those performance statistics and further displays those generated performance statistics adjacent to the corresponding associated clauses.

Examples of these clauses include those associated with specific tables of the database. For example, clauses that include table references, a column reference, or a predicate will have associated statistics. The statistics may be performance statistics generated in response to an “explain” command and/or statistics maintained by the database system in catalog tables.

The present invention further assists the database analyst computer user 5 by allowing the analyst to select one of the clauses and then responding by automatically highlighting each of the other clauses that are related to the selected clause. In one embodiment the present invention differentiates between simple query predicate clauses and joins query predicate clauses when implementing this highlighting feature. For example, when the selected clause is a join predicate, the graphic display window 201 highlights clauses that are associated with the selected join query clause by a common table name. In certain embodiments, the graphic display window 201 accomplishes the highlighting by changing the background color of the display text font for both the selected clause and the associated clauses.

In one embodiment, the graphic display window 201 includes a selection mechanism, such as a displayed menu. Advantageously, this allows an analyst 5 to select which performance statistics are displayed adjacent to the formatted SQL query clauses in the graphical display window 201. The type of performance statistics that we have generated include, but are not limited to: catalog data, cost estimates, filter factors, and column cardinalities, highest and lowest values of column, histograms, and frequency statistics.

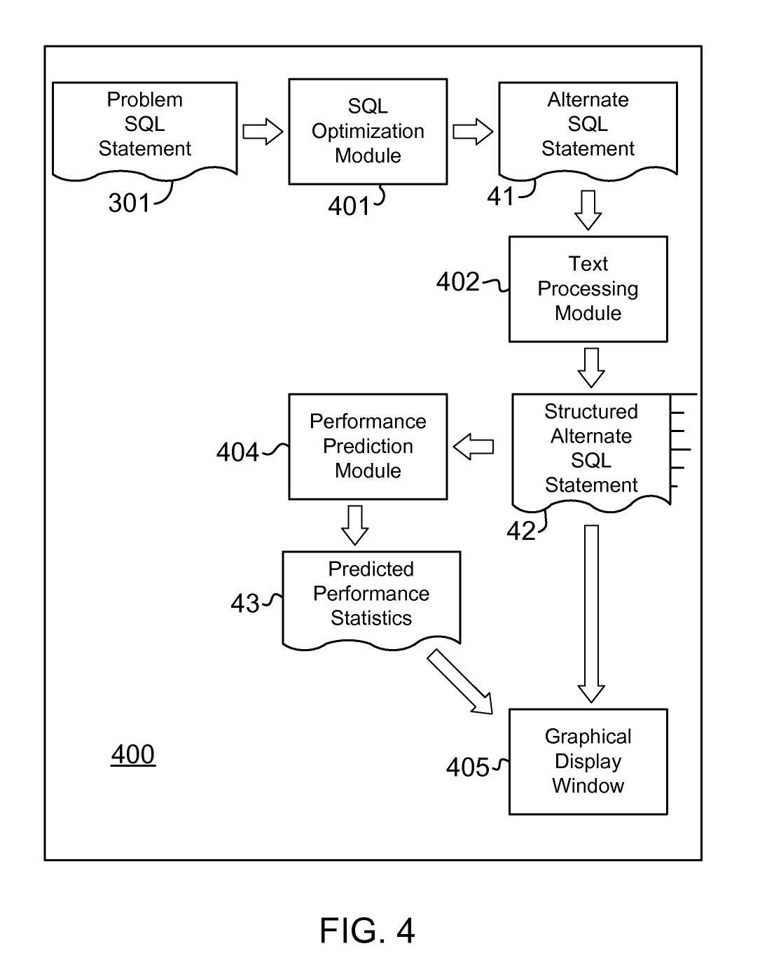

A second embodiment of the present invention provides a system 400 for analyzing the problem SQL statement 301 shown in FIG. 3. This inventive system 400 is illustrated in FIG. 4. The following description refers to FIGS. 1 through 4.

A SQL optimization module 401, such as for example, a particular application program 20 executing at the user interface 10, receives a problem SQL statement 301 and transforms the problem SQL statement 301 into an alternate form 41 which may be more efficient. This alternate form 41 includes suggested changes to at least one of the query clauses of the original SQL problem statement 301. The alternate form SQL statement 41 is sent from the SQL optimization module 401 to a text processing module 402.

Text processing module 402 parses the alternate form SQL statement 41 into a plurality of alternate query clauses and formats these alternate clauses into a hierarchical tree structure 42 including one alternate SQL query clause per indented line. The text processing module 402 transfers the formatted alternate SQL statement 42 to both a performance prediction module 404 and a graphical display window 405.

The performance prediction module 404 preferably runs at the user interface 10 instead of the DBMS 40. This performance prediction module 404 generates predicted performance statistics 43 for the alternate clauses that would have associated statistics if they were to be run by the DBMS 40. Each of the predicted performance statistics 43 corresponds to a specific alternate query clause within the formatted alternate SQL statement 42. These predicted performance statistics can include, but are not limited to: catalog data, cost estimates, filter factors, and column cardinalities. The performance prediction module 404 transfers the predicted performance statistics 43 to the graphical display window 405.

Graphical display window 405 displays both the formatted alternate SQL statement 42 and the predicted performance statistics 43 in such a manner that each of the alternate query clauses are displayed on a separate display line and are displayed adjacent to a corresponding associated performance statistic. In one embodiment, the formatted alternate SQL statement 42 and the predicted performance statistics 43 are displayed in one tab and the problem SQL statement 301 with associated predicted performance statistics are displayed in a separate tab. In another embodiment, the graphical display window 201 displays the predicted performance statistics 43 and a version of the problem SQL statement 301 that includes markup features indicating text sections of the problem SQL statement that were added, deleted, or revised by the SQL optimization module 401 to generate the alternate SQL statement 42.

In a further embodiment of the present invention, the suggested alternate clauses generated by the SQL optimization module 401 are semantically equivalent to SQL query clauses within the problem SQL statement 301. According to this further embodiment, the SQL optimization module 401 is configured to provide offered explanations for each of the suggested clause changes and the graphical display window 405 displays each of these offered explanations adjacent to the corresponding alternate clause.

In certain embodiments, the graphical display window 405 allows an analyst 5 to save or print the annotations, including the predicted performance statistics 43, the problem SQL statement 301, and/or the alternate SQL statement 42, with or without markup features. Preferably, the saved or printed version reflects the same formatting provided in the display window 405.

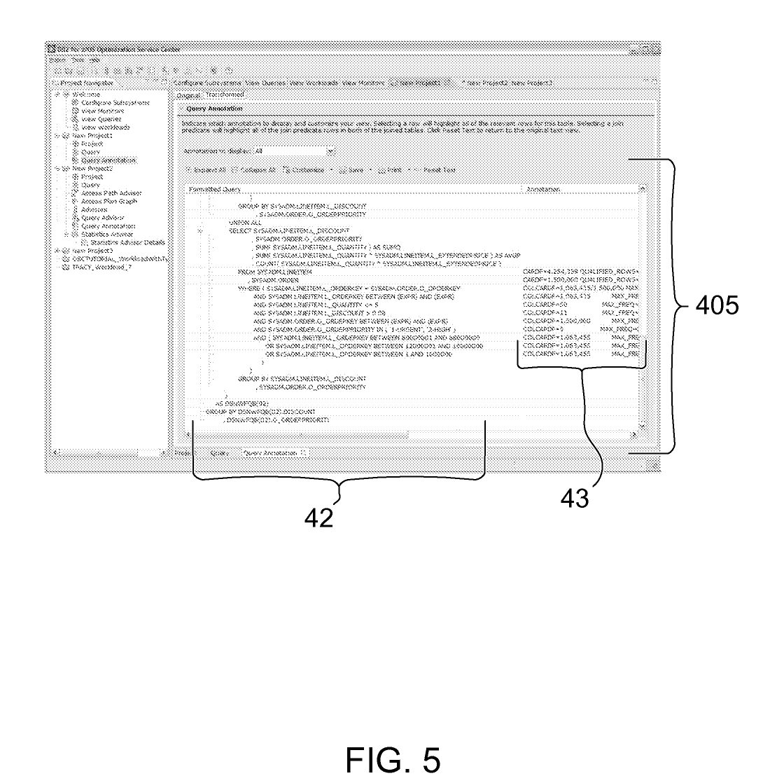

FIG. 5 depicts an illustrative screen shot of the graphical display window 405 of system 400 according to one embodiment of the present invention. The screen shot shows displays both the formatted alternate SQL statement 42 and the predicted performance statistics 43. It should be noted that the screen shot displays the bottom portion of the formatted alternate SQL statement 42. Those of skill in the art will recognize that embodiments of the present invention are configured to format and display both problem SQL statements and/or alternate SQL statements 42 that include subqueries. For example the text processing module in one embodiment is configured to parse the problem SQL statements and/or alternate SQL statements 42 into a plurality of clauses according to the defined syntax for SQL statements. In addition, in one embodiment, the graphical display is configured to display the plurality of clauses in a hierarchical manner.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code programmed for annotating a problem SQL statement, the operations of the computer program product comprising:
receiving a problem SQL statement from one of a plurality of SQL statement sources;
parsing the problem SQL statement into a plurality of clauses;
formatting the plurality of clauses into a hierarchical tree structure comprising indented lines where each of the clauses is contained on one of the indented lines;
displaying each of the indented lines containing the parsed clauses of the problem SQL statement on a separate line within a display window;
generating performance statistics for the clauses having associated statistics, wherein each performance statistic corresponds to a specific clause; and
annotating the problem SQL statement by displaying one or more performance statistics on a line within the display window such that the one or more performance statistics are displayed adjacent to the corresponding clause.

2. The computer program product of claim 1 wherein the plurality of clauses includes simple query predicates and join query predicates and the operations of the computer program product further comprise:
accepting operator inputs to select one of the clauses; and
automatically highlighting other of the clauses that are related to the selected clause.

3. The computer program product of claim 2 wherein:
the selected clause is a join predicate and the highlighted clauses are associated with the selected join predicate by a common table name; and
the highlighting comprises changing the background color of the displayed text font for both the selected clause and the associated clauses.

4. The computer program product of claim 1 wherein a menu comprising a plurality of selectable performance statistics is presented to an operator and the operations of the computer program product further comprise:
accepting operator inputs to select at least one of the performance statistics that are displayed in the display window.

5. The computer program product of claim 1 wherein:
the SQL statement sources comprise
SQL statement lists generated by a query monitoring tool internal to a database management system,
SQL statements contained within a dynamic statement cache of the database management system,
SQL statement lists generated by a query reporting tool external to the data base management system,
SQL statement lists contained in a database catalog,
an alternate form of an original SQL statement that has been generated by a database optimizer, and
SQL statement lists imported from a file or copied or typed into a text field; and
the performance statistics comprise one or more of
catalog data, cost estimates, filter factors, column cardinalities, highest and lowest values of column, histograms, and frequency information.

6. A system for analyzing a problem SQL statement, the system comprising:
an SQL optimization module configured to receive a problem SQL statement and transform the problem SQL statement into an alternate form that includes suggesting clause changes;
a text processing module configured to parse the alternate form SQL statement into a plurality of alternate clauses and to format the alternate clauses into a hierarchical tree structure comprising indented lines where each of the alternate clauses is positioned on one of the indented lines;
a performance prediction module configured to predict performance statistics for the alternate clauses having associated statistics, wherein each predicted performance statistic corresponds to a specific alternate clauses; and
a graphical display configured to display each of the indented lines containing the parsed alternate clauses of the alternate SQL statement on a separate line within a display window and one or more predicted performance statistics adjacent to the corresponding alternate clause.

7. The system of claim 6 wherein:
the suggested clause changes comprise semantically equivalent SQL query clauses
the optimization module is further configured to offer explanations for each of the suggested clause changes; and
the graphical display is further configured to display each of the explanations adjacent to the corresponding alternate clause.

8. The system of claim 6 wherein the predicted performance statistics comprise:
catalog data, cost estimates, filter factors, column cardinalities, highest and lowest values of column, histograms, and frequency statistics.
